(19) United States
(12) Patent Application Publication
(10) Pub. No.: US 2019/0110445 A1
(43) Pub. Date: Apr. 18, 2019

(54) VARIABLE CONVEYOR/ELEVATOR

(71) Applicant: GSI Brasil Industria e Comercio de Equipamentos Agropecuarios Ltda, Rio Gmde do Sul (BR)

(72) Inventor: Rudolf GIOVANI PORTELA, Marau (BR)

(21) Appl. No.: 16/096,982

(22) PCT Filed: Apr. 26, 2017
(86) PCT No.: PCT/IB2017/000480

§ 371 Date: Oct. 26, 2018

(30) Foreign Application Priority Data
Apr. 26, 2016 (BR) 102016009259

(51) Int. Cl. A01K 43/00; B65G 17/06; B65G 17/36

(52) U.S. Cl. CPC A01K 43/00; B65G 2201/0208; B65G 17/36; B65G 17/066

(57) ABSTRACT

A conveyor/elevator for raising ovate objects includes a lower support with a contact surface having a minimum radius equal or greater than the radius of the ovate object to be moved. A side support with opposed concave surfaces which have a minimum radius equal or greater than the ovate object, wherein each surface has at least one support point for the ovate object. The concave surfaces have a last possible support point, in the direction towards the outside of the conveyor/elevator, at the intersection of a line parallel with the line of centre of gravity of the ovate object, with a distance relative to the line of a centre of gravity of the ovate object between the minimum of 2 mm and the maximum equal to the radius of the ovate object and a line perpendicular to the line of centre of gravity of the ovate object.

### BACKGROUND

### Field of The Invention

This invention relates to the field of equipment and devices used on laying poultry farms both for the production of table eggs intended for consumption and for hatching eggs intended for incubation, relating specifically to a variable conveyor/elevator suitable for ovate solids but specifically for receiving and moving eggs.

### Discussion of Related Art

Various devices are known for raising generally round or ovate objects such as, for example, fruit, cylinders and especially eggs, from a lower level, unloading them at a higher level or raising them from a lower level, going via a higher level and unloading them at another lower level or going to several levels, whether lower or higher and unloading them at a different level or even moving them in a straight, inclined or curved line.

Specifically the movement of eggs, without there being a need for human contact with the eggs, takes on greater importance every day whether this is due to the need for greater health control of production to reduce the risk of contamination of, for example, hatching eggs for production of chicks or production of vaccines or due to the shortage of labour and the cost of the labour necessary for collecting eggs as, for example, in the production of table eggs intended for sale in supermarkets or industrial preparation which, due to the large daily volume of eggs, would impede production if collection and movement to the processing premises were carried out manually or in a semi-automated way.

Eggs produced in laying cages or automatic nests need to be moved to premises outside the laying premises, in order then to undergo processes such as washing, disinfection, grading, packing or are even processed to obtain liquid or powdered egg.

The great challenge for facilitating even further the use of mechanised systems of egg collection and movement is to have one single piece of equipment which is capable of moving the production from the point of loading to its unloading, whether it has or does not have intermediate loading points, adapting to the most varied types of land relief, from flat to uneven with varying inclinations of up to ninety degrees and even crossing over obstacles, forming curves in any direction, adapting to the various different arrangements of the production sheds. Another challenge is to move the production so that losses do not occur during the process of movement in this way, increasing profitability for the producer.

U.S. Pat. No. 1,457,562 relates to a fruit vertical elevator where the object is to transfer from a lower point to a higher unloading point, this elevator even being provided with concave supports. The device of the patent is used for lifting the load as described in the patent, it not being possible to move the product horizontally. U.S. Pat. No. 1,892,670 also describes an apparatus for handling articles, more specifically of a cylindrical shape or generated by rotation, not, however, being limited to these shapes where the object is to transfer the articles from one level to another lower level, where, one by one, the articles, more specifically rolls, are transferred from a horizontal conveyor to the vertical conveyor by means of a transfer mechanism. As the American patent describes, the vertical conveyor is formed by a belt passing around an upper pulley and by another similar pulley in the lower portion having, in the above-mentioned belt, supports or arms fastened at points suitably spaced, the vertical and horizontal space existing between the supports being adjusted to the space suitable for an egg of any size and the geometry of the supports not even being specifically described, the drawings presented in the patent show a person skilled in the art that, with the supports being adapted to the proportions of any egg, this conveyor would be of use for moving this egg from a higher level to a lower level but has the drawback of necessarily being fed by a conveyor which has already received the load in some other way and other equipment responsible for the transfer of the article from this second conveyor to the elevator in order then to continue the process of moving the article or egg.

U.S. Pat. No. 3,111,215 describes the improvement introduced into the management of fresh egg collection, having the object of providing a means of removing the fresh eggs from the collection compartment of the nest referred to in U.S. Pat. No. 2,695,006. It is described that the article used in connection with multiple nests, capable of being extended to any size so as to pass in front of all the nests having at any point the load of eggs, also equally adaptable to other laying nests arranged in lines on the same level, moving the fresh eggs from the said nests and moving them to other areas. It is also described that the conveyor can move along a channel with a slight positive or negative slope relative to the horizontal, having as a special feature of the invention the free movement of a series of metal, plastic or rubber fingers called “flights” fastened to a steel cable which passes along the inner wall of a channel and—with the horizontal movement of a wheel at one or both ends of the above-mentioned conveyor—causes the displacement of the fingers called “flights” in this way moving the eggs which are on the “flights”. The drawbacks of the new proposal are innumerable, among the main drawbacks there being the need for the laying nests to be arranged in lines and on the same level and for accepting only a slight positive or negative slope relative to the horizontal; for example, it cannot operate between three egg collecting points when there is more than one difference in levels and these collecting points are out of alignment with one another.

U.S. Pat. No. 3,166,175 relates in particular to an egg conveying apparatus which provides a device for moving eggs, having one single elevator and means for receiving eggs at any level and transferring the eggs to the desired level, by means of an egg elevator and a conveyor which can be vertically adjustable relative to each other, providing one single elevator able or co-operating adjustably with any number of movement levels to serve one or more floors of a hen house and accommodate any number of individual nests spaced vertically, provide an adjustable lifting apparatus having adjustable transfer of eggs, transferring the eggs from the level of the conveyor to the elevator in ideal conditions, also provide an egg lifting apparatus not having only controlled the conditions of transferring the eggs from the conveyor to the elevator but also controlling the transfer of the eggs from the elevator to the receiving surface of the collecting centre. Other objects of the invention are also stated. However, the main drawback of the object described is the fact that this elevator cannot bend to the right or left or move the load of eggs horizontally.

U.S. Pat. No. 3,626,905 describes a solution to the problem of removing eggs from a battery of multiple lines, the said battery comprising a plurality of juxtaposed laying cages. As described, eggs are collected in the vertical direction by means of a suitable receptacle described as a small basket which they can, [sic] collecting the eggs in the direction of the line from the lowest level to the highest one and by means of the rotary movement imposed by the drive system. The eggs collected are placed in a second horizontal conveyor installed on the side opposite the egg collecting side. This being the case, this equipment operates in the two directions of lifting and lowering the eggs in the vertical, as also stated in the patent. Another embodiment of the arrangement according to the invention also consists of having small baskets which are of triangular cross section or rectangular or multi-angular shape. No detailed description of this equipment is necessary, as it is stated initially that it relates to a vertical elevator which has the drawback of not continuing movement on a horizontal plane without the need for a transfer from the elevator to a second horizontal conveyor which can also adapt to the conditions imposed by the relief.

British patent GB1475954 already describes a conveyor, particularly an escalator for moving eggs or articles of a similar shape up or down on a slope where the eggs pass from a horizontal conveyor to the escalator which is provided with V-shaped supports which are used for receiving the eggs and taking them, with the displacement of the escalator, to a second conveyor at either a lower or a higher level, there being a portion for carrying out the transfer of the eggs from the first horizontal conveyor to the escalator and a second portion for carrying out the transfer of the eggs from the escalator to the second horizontal conveyor. There are several drawbacks to this escalator, the main drawback being the need for two transfers of the eggs, the first transfer being from one conveyor to the escalator and the second transfer being from the escalator to a second conveyor, thereby increasing the problems of hairline cracks in the shells, impeding incubation.

Also known are U.S. Pat. Nos. 4,096,943, 3,842,968, 6,945,388, 4,096,943, [sic] U.S. Pat. Nos. 4,301,915 and 3,708,059 which relate to “snap-on” type systems, these being systems of snapping on surfaces or plates for being mounted on a roller chain, these surfaces or plates forming one or more supports making it possible for articles to be moved on these surfaces or plates. Specifically, patents U.S. Pat. Nos. 4,301,915 and 3,708,059 provide surfaces formed by two wires, these surfaces having a certain similarity to the supports presented in U.S. Pat. No. 3,111,215. This being the case, these supports could also be used in egg conveyors although, due to being formed by two wires in one single plane, there would only be the possibility of moving one specific size of egg and only in the horizontal plane, there being no possibility of moving an egg or ovate solid in a perpendicular plane. The plates and surfaces of the other patents referred to are not capable of moving eggs in a horizontal plane without significant losses as they are flat surfaces which allow the eggs to roll during movement, causing impacts and consequently breakages and/or hairline cracks in the shells. In the detailed description of the proposed object, a variable conveyor/elevator, it will be possible to identify the use of a roller chain of the “side bow” type with which it is possible to form lateral bends in a horizontal plane, the centre lines of the chain pins forming an angle between one another and descending and ascending bends characteristic of roller chains and also the use of a “snap-on” type of fitting system for fastening the egg supports.

U.S. Pat. No. 4,244,464 provides a conveyor for eggs in particular comprising two link chains, one on each side being extended in a perpendicular plane, the chains being interconnected by a number of transverse bars forming a conveying surface, where successive bars have a different level on a common plane of reference so that, at least the upper surface of every second bar is at a higher level than the upper surface of the first bar. Here, the eggs are always supported (placed) on two bars (supports, surfaces) of different planes and can thus be moved through steeper upward slopes without rolling back, although this object also has the drawback which is the strong possibility of egg breakage and cracks or hairline cracks in the egg shells when there is loading from the mat in the direction crosswise to the direction of conveying movement, as the object is formed by two link chains, one on each side, these links forming an obstacle to the free rolling of the eggs at one single level of the bar welded to the link oriented in the horizontal direction or even, as the bar welded to the link oriented horizontally increases the vertical distance relative to the bar welded to the link oriented vertically, the conveyor tends to overcome greater conveying movement slopes relative to a horizontal plane although, consequently, a v-shaped depression forms between three bars, whereby the fall of an egg loaded laterally is even greater. The distance of the fall will be equal to the distance measured vertically between the upper tangent of the bar which is at a higher level and the upper tangent of the bar which is at a lower level, this fall resulting in losses for the egg producer.

Also known are U.S. Pat. Nos. 4,293,066, 5,002,016, publication US2009/0159012, U.S. Pat. No. 7,958,849 and subsequent publications US2012/0255499, U.S. Pat. No. 5,002,016 [sic] and WO2012/044156, in which both the patents and the publications refer to systems, equipment and/or method of use for the lifting (elevators) of articles, more specifically eggs, these having the drawbacks, in relation to the proposed object, of not forming bends either to the right or to the left in a horizontal plane.

Patent ES 2012162 is known and refers to an endless conveyor, especially for collecting eggs from avian cages, intended for the movement of eggs from the fall along the inclined planes of the bottoms of the cages to the general collector. It comprises two parallel traction elements formed by steel cables on which is situated a succession of parallel rods substantially positioned equidistantly and fastened by the ends to the steel cables and forming a receiving bed for the eggs. The conveyor is moved by a drive which comprises at least one wheel provided with grooves which are adapted to the geometry of the rods, allowing sunken fitting of part of the rods whether during movement or in the stationary state. The distance between the two successive rods is such that eggs of a certain size can be supported in a substantially stable manner and moved in a substantially horizontal plane. This conveyor described in the patent for invention also has drawbacks, the main one being that only the eggs of essentially similar sizes can be moved stably, as the distance between the rods is generally associated with the average size of an egg. Eggs of sizes different from the average will not be moved stably in a horizontal plane. They will be even less stable when the conveyor is inclined and the eggs cannot be moved in an inclined plane forming a perpendicular to a horizontal plane.

Also known is European patent EP1344728-A1 which deals with the invention of a conveyor for products, particularly eggs, comprising at least one movement unit which is provided with at least one receiving space for containing at least one egg, a first limit (support) on one side of the receiving space and a second limit (support) which is positioned on an opposite side of the receiving space and which follows the first limit in the direction of movement. The object of the invention is to supply a conveyor track for moving eggs, in which the eggs—irrespective of the slope and curvature of the conveyor track and the size of the eggs—can be moved in a relatively controlled manner without significant loss of production, it being claimed that the first limit (support) is provided with a first support surface (22) adapted for supporting the product, forms an angle with the vertical which is between 25° and 35°, in particular 30° and the second limit (support) is provided with a second support surface (23) adapted for supporting the product in which the second support surface and the vertical form an angle which is between 15° and 25°, in particular 20°. Nevertheless, the object of patent EP1344728-A1 has the drawback of not eliminating the need for an egg elevator for overcoming descending or ascending routes when the angle formed by the inclination of the conveyor with a horizontal plane is equal to or greater than the complementary angles of support surfaces one and two which relate to a vertical plane.

Patent EP1344728-A1 presents a section of the conveyor showing one ascending inclination and another descending one which are of angle α, formed with a horizontal and it also shows a movement unit, the limits, the surfaces of these limits and the respective angles. As described in the patent, β is between 25° and 35°, in particular 30° and γ is between 15° and 25°, in particular 20°, both of the surfaces being with the angles relating to a vertical. For the descending side of the direction of movement, if the conveyor is horizontal, consequently the angle α will be equal to zero with a horizontal plane α=0° and β with a vertical between 25° and 35°, in particular 30° due to the complementarity of angles (the name ϕ being given to the complementary angle). The maximum value for angle α in that it represents the inclination of the conveyor on the descending side in the direction of movement relating to a horizontal will therefore be between 55° and 65°, a range of angles in which the first support surface coincides with the horizontal plane whereby the movement of eggs becomes unstable, the eggs being able to roll forwards, causing damage. If the same analysis is carried out, for the ascending direction of the conveyor where the second support surface forms an angle γ between 15° and 25° relating to a vertical, the maximum, value for angle α which represents the inclination of the conveyor on the ascending side in the direction of movement relating to a horizontal will be between 65° and 75°, a range of angles in which the second support surface coincides with the horizontal plane whereby the movement of eggs becomes unstable, the eggs being able to roll backwards, causing damage.

In conclusion, if the angle of inclination a of the conveyor with a horizontal is 76 degrees, both in the ascending direction and in the descending direction, the eggs will roll, with total unloading of the conveyor, causing great damage.

### BRIEF SUMMARY OF THE INVENTION

Therefore, one of the objects of this invention is to eliminate the need for a specific elevator (lift) for eggs which carries out movement from a lower point to a higher point or specific equipment which moves the products from a higher point to a lower point, both of these pieces of equipment forming or not forming right angles, acute or obtuse angles relating to a horizontal plane and/or forming right angles, acute or obtuse angles with another plane perpendicular to the horizontal plane.

Another object of this invention is to move eggs in the same movement system without the need to transfer eggs from a first movement unit to another, specific second movement unit which makes it possible to overcome routes with ascending and/or descending inclinations with angles in the ascending and/or descending portion between 0° and 90° relating to a horizontal plane, forming bends to the right or to the left in one single horizontal plane and even with the entry to a bend to the right or left in one horizontal plane and the exit from the bend in a horizontal plane higher or lower than the entry.

This invention achieves the above objects among others by means of a conveyor which can move eggs with the said conveyor coinciding with a vertical plane, thus eliminating the need for an elevator, reducing the cost of installation, not needing to transfer the eggs from one conveyor to the elevator and again to another conveyor, giving rise to greater advantage being taken of the production, due to the reduction of breakages and cracks in the eggs to minimum levels, resulting in greater financial gains for the producer.

One aspect of the invention is directed to a variable conveyor/elevator for raising ovate objects having a radius from a lower level to a higher level and unloading the ovate objects. The variable conveyor/elevator includes a lower support (1) configured to form a contact surface (2) in which the contact surface (2) of the lower support (1) has a minimum radius (3) equal to or greater than the radius of the ovate object (4) to be moved, wherein the lower support (1) provides at least one support point (5) for the ovate object (4), said support point (5) forming an area of contact with the ovate object (4). The variable conveyor/elevator includes a side support (6) with opposed concave surfaces (7) and (8) which have a minimum radius (9) equal to or greater than the radius of the ovate object (4) to be moved, wherein each surface (7) and (8) has at least one support point (10) for the ovate object (4), forming an area of contact with the ovate object (4), characterised in that the concave surfaces (7) and (8) have a last possible support point (11), out in the direction (12) towards the outside of the conveyor/elevator, situated at the intersection of a line (13) parallel with the line of centre of gravity (14) of the ovate object (4), with a distance (15) relative to the line of a centre of gravity (14) of the ovate object (4) between the minimum of 2 mm and the maximum equal to the radius of the ovate object (4) to be moved and a line (16) perpendicular to the line of centre of gravity (14) of the ovate object (4) with the distance (17) from the centre of gravity (18) of the ovate object (4) in the direction of the concave surfaces (7) and (8) between the minimum value equal to the difference of the subtraction of 1 mm from the value of the radius of the largest ovate object (4) and maximum value equal to 1 mm.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a view of the side support (6) and of the lower support (1) of the elevator/conveyor in the horizontal position when idle;

FIG. 2 is a view showing the area of contact (7) and (8) of the side support (6) with the product being moved (in this case, an egg) (4);

FIG. 3 is a front view of the side support (6) on the “side bow” type of roller chain (20);

FIG. 4 shows a perspective view of the side support (6) and lower support (1) mounted sequentially in an uninterrupted manner on the roller chain (20) so as to form a movement track as long as specifically required for each installation;

FIG. 5 shows a side view of the side support (6) and lower support (1) mounted sequentially in an uninterrupted manner on the roller chain (20) so as to form a movement track as long as specifically required for each installation;

FIG. 6 shows a cross section view of the movement track mounted on the supporting sections;

FIG. 7 shows a perspective section of the movement track mounted on the supporting section structure;

FIG. 8 shows in cutaway view an example of a conveyor with the movement track chain engaged on the sprockets of the front and intermediate drive units and return end drive unit on the right;

FIG. 9 shows in perspective an example of a conveyor with the front, intermediate and end drive units;

FIG. 10 shows a top view of a section in a horizontal plane of the movement track mounted on the supporting section structure, having four flat bends with angles of ninety degrees;

FIG. 11 shows the section in FIG. 10 in perspective;

FIG. 12 is a sectional drawing of a front view of the movement track mounted on the supporting section structure, showing four ninety-degree bends, two of them being ascending bends and two of them being descending bends, forming between the bends two movement sections perpendicular to the horizontal plane of movement. It also shows the details of displacement of the egg during the movement from a point A in the horizontal, going through points C and F in the vertical to point G;

FIG. 13 shows a perspective view of the movement track mounted on the supporting sections, showing four ninety-degree bends, two of them being ascending bends and two of them being descending bends;

FIG. 14 shows a perspective view of an application of an example of a conveyor coupled to an automatic nest (32) with loading of the movement track at right angles to the direction of movement;

FIG. 15 shows a perspective view of another possible configuration of the conveyor in a helical form, making lifting possible from a lower level to a higher level and vice versa;

FIG. 16 shows a cutaway front view of another possible configuration of the conveyor coupled to a battery of laying cages, the eggs being loaded perpendicularly to the direction of movement, from the lowest portion to the highest portion;

FIG. 17 shows a perspective view of FIG. 16 without the battery of laying cages;

FIG. 18 shows another possible configuration of the conveyor, the movement track being formed by the mounting of the side support (6) and lower support (1) on a welded-link chain;

FIG. 19 shows a perspective view of FIG. 18; and

FIG. 20 shows a front view of an extreme configuration of the side support 6 and lower support 1 but which still allows the formation of ascending or descending bends to the right and to the left, where the last possible support point tends to equate to the radius of the largest possible product to be moved.

Corresponding reference characters indicate corresponding parts throughout the views of the drawings.

### DETAILED DESCRIPTION OF THE INVENTION

This invention will be described below in greater detail based on the exemplary embodiments shown in the drawings. To this end, although the illustrations show the elevator moving eggs, it must be understood that the said conveyor can be applied to any movement of ovate products.

Turning now to the Figures, a variable conveyor/elevator (100) for movement of eggs and other generally ovate objects is configured to move and lift the eggs having geometry formed by the rotation of a surface and more specifically to move from a loading point A to an unloading point B, having or not having intermediate loading points between A and B, the conveyor being capable of being loaded in the direction of movement, perpendicularly or even transversely (laterally) to the direction of movement, adapting to the most varied installation conditions such as: distance between A and B, differences in level between A and B, having or not having ascending or descending sections forming or not forming right angles, acute or obtuse angles relative to a horizontal plane and/or forming right angles, acute or obtuse angles with another plane perpendicular to the horizontal plane, impositions of civil engineering such as the need for bends to both the right and the left with different angles, combinations of bends of unequal height, it being possible to form a spiral with either an ascending or a descending direction of movement, any misalignments and even the customer's specific requirements.

Basically, the conveyor/elevator (100) is formed by two supports: a lower support and a side support, fastened sequentially on to a roller chain, preferably of the “side bow” type, with which it is possible to form ascending and descending bends and also bends to both the right and the left, the sequence of supports forming an endless uninterrupted movement track. The movement track is mounted on a structure formed by sections and these sections can be made of plastics, composites or metals. The section structure provides support for the movement track.

Movement in both of the directions of the movement track is provided by at least one drive unit installed at one end of the conveyor, point B for example (but not limited to this), the drive unit preferably being formed by an electric motor and a reducer or motor and transmission system which manages torque, the drive unit being connected to a shaft which, in turn, has a sprocket fastened to it so as to engage with the roller chain and transmit turning movement to the roller chain, causing the linear displacement of the movement track. At the other end, point A, there is another sprocket connected to a bearing-mounted shaft allowing free rotation or, depending on the length of the movement track, there can also be another end drive unit at point A so as to divide the effort necessary for driving the movement track, it also being possible for there to be intermediate auxiliary units which can be installed at any distance between points A and B and if there is only one auxiliary unit, this is preferably at the central point between A and B.

For control of the drive unit or drive units, it is preferable to use an electrical panel provided with a frequency inverter connected to each motor, making it possible to vary the frequency of the electrical current supplied to the electric motor, thereby making it possible to adjust the speed of the movement track according to the operator's requirements or the requirements of any machine fed by the conveyor. Other means of varying the movement track speed can be used such as, for example, a mechanical variable speed unit connected between the reducer and motor or even the use of direct current motors with electronic variable speed unit.

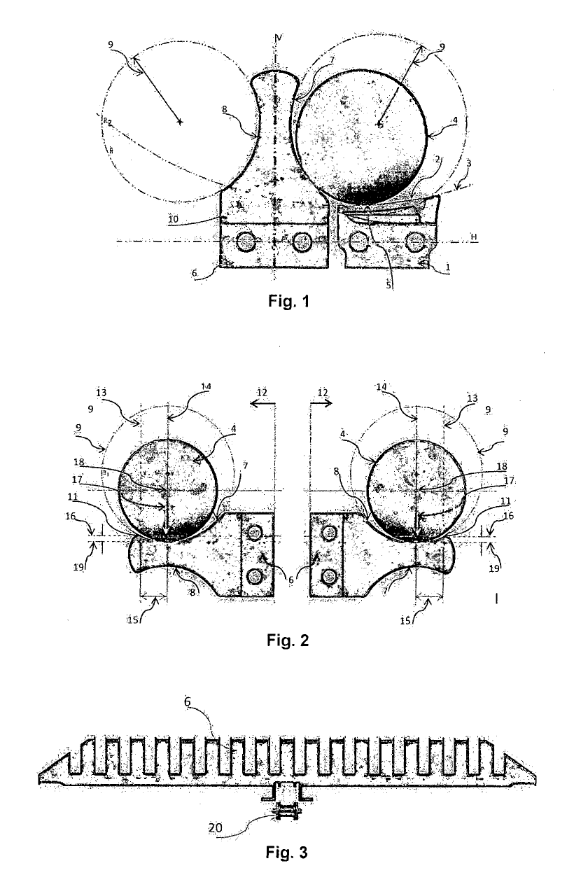

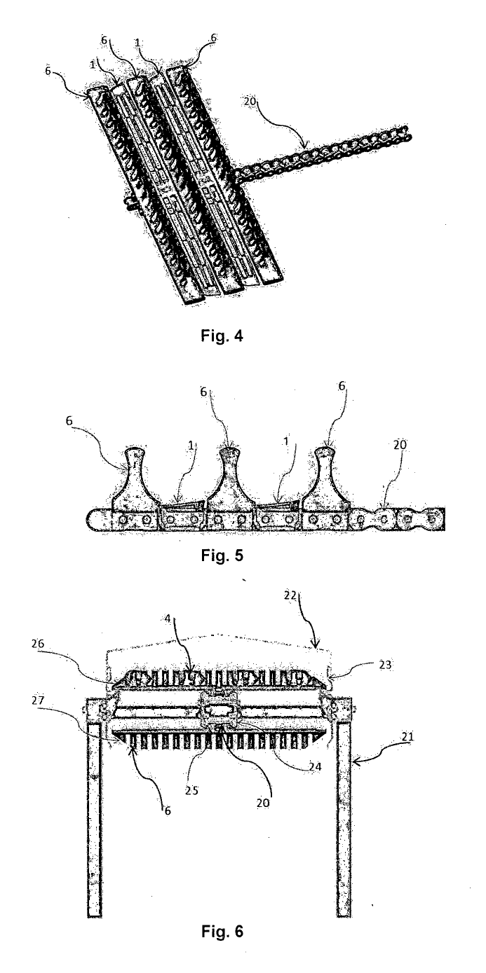

The variable conveyor/elevator (100) according to FIG. 1 in the idle horizontal position is formed by a lower support (1) in which the contact surface (2) of the lower support (1) has a minimum radius (3) equal to or preferably greater than the radius of the largest product (4) moved, providing at least one support point (5) for the product (4), preferably forming an area of contact with the product (4), a side support (6) with opposed concave surfaces (7) and (8) which have a minimum radius (9) equal to or greater than the radius of the largest product (4) moved, providing on each surface (7) and (8) at least one support point (10) for the product (4), preferably forming an area of contact with the product (4), according to FIG. 2, the concave surfaces (7) and (8) having a last possible support point (11), out in the direction (12) towards the outside of the conveyor, situated at the intersection of a line (13) parallel with the line of centre of gravity (14) of the product (4), with the distance (15) relative to the line of centre of gravity (14) of the product (4) between the minimum of 2 mm and the maximum equal to the radius of the largest product (4) moved and a line (16) perpendicular to the line of centre of gravity (14) of the product (4) with the distance (17) from the centre of gravity (18) of the product (4) in the direction of the concave surfaces (7) and (8) between the minimum value equal to the difference of the subtraction of 1 mm from the value of the radius of the largest product (4) and maximum value equal to 1 mm.

FIG. 3 shows the side support (6) being inclined at an angle of 90° from a horizontal straight line. However, the inclination of the support (6) cannot be limited to 90°; the last possible support point (11) is always located above the line (19) at a tangent to the concave surfaces (7) and (8) and perpendicular to the line of centre of gravity (14) of the product (4) and with outlying position parallel with the line of centre of gravity (14) of the product (4) in the direction (12) towards the outside of the conveyor. Thus the greater the distance (15)—this tending to equate to the radius of the largest product (4) moved—and the smaller the distance (17), the safer the movement of the product (4) on ascending and descending routes even at angles beyond 90°. Furthermore, a person skilled in the art will recognise that this invention can be configured in other specific forms without departing from the spirit or purpose defined in the attached claims.

The variable conveyor/elevator (100) has a movement track formed by the consecutive “side bow” type roller chain (20) and mounts the lower support (1) and the side support (6) so as to form an uninterrupted movement track. Desirably, the movement track is formed by mounting the at least one lower support (1) with one side support (6) to the right of the lower support (1) and one side support (6) to the left. The roller chain (20) desirably is formed of link-chains made of plastic, composites or steel. Alternately, the roller chain (20) is formed by anchoring in one or a plurality of cables or malleable strips of steel, composites or plastic, to the at least one lower support (1) and one side support (6).

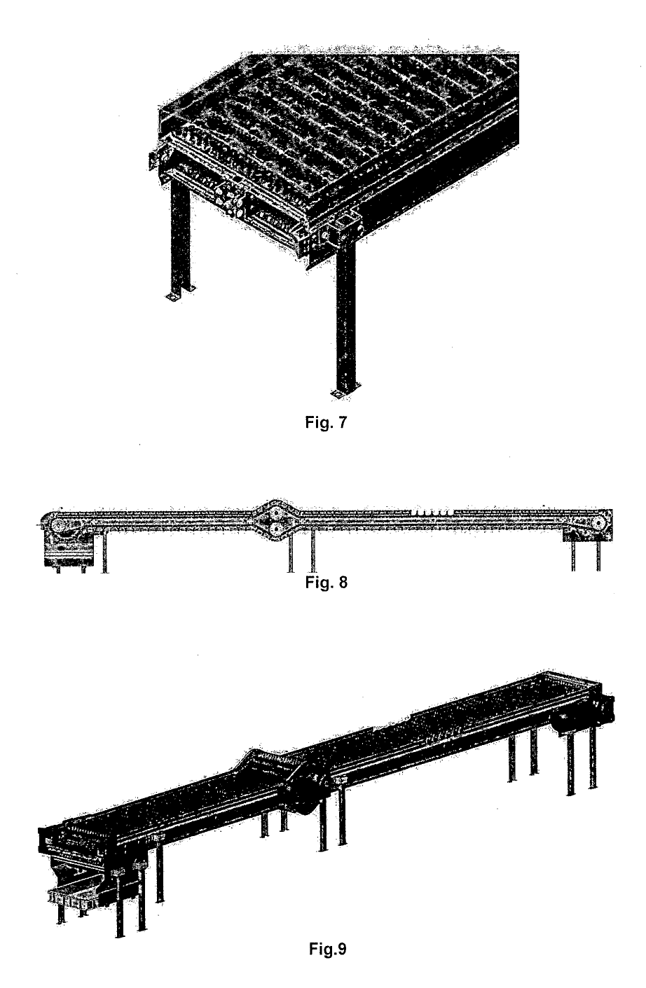

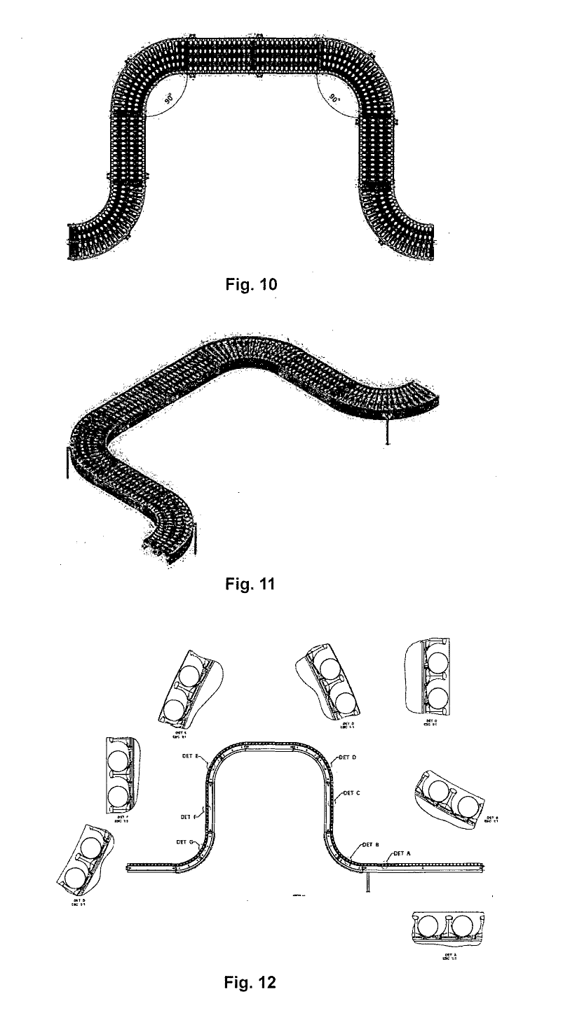

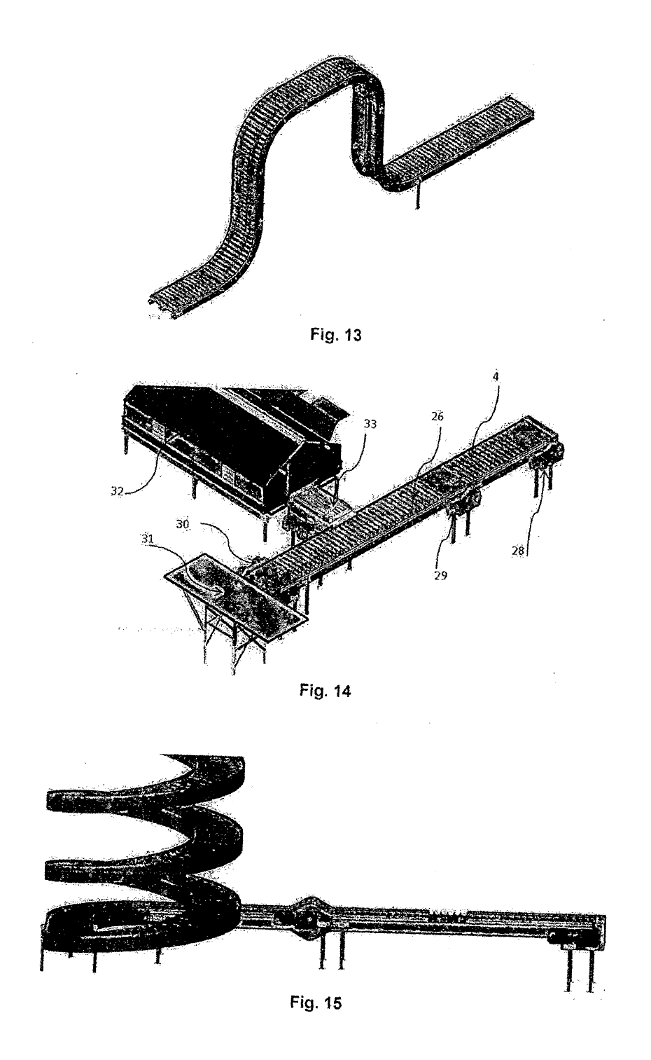

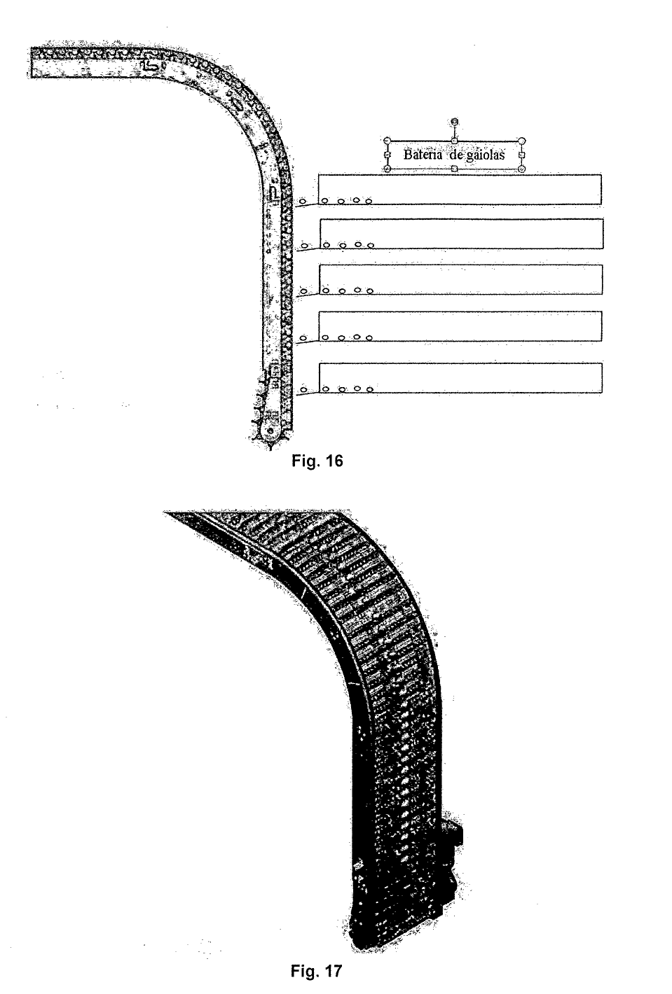

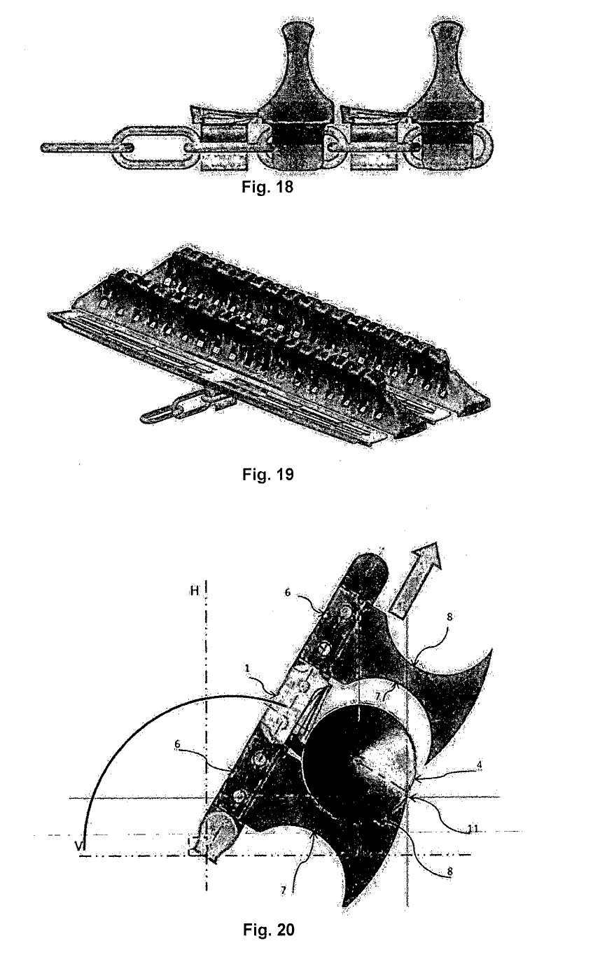

In one embodiment, the movement track chain (20) engages on sprockets of a front and intermediate drive units and return end drive unit. As shown in FIG. 7, the movement track is desirably mounted on a supporting section structure. FIG. 10 shows a top view of one embodiment of the movement track mounted on the supporting section structure, having four flat bends with angles of ninety degrees. FIG. 12 shows the movement track mounted on the supporting section structure, showing four ninety-degree bends, two of them being ascending bends and two of them being descending bends, forming between the bends two movement sections perpendicular to the horizontal plane of movement. It also shows the details of displacement of the egg during the movement from a point A in the horizontal, going through points C and F in the vertical to point G. FIG. 14 shows a perspective view of an application of an example of a conveyor coupled to an automatic nest (32) with loading of the movement track at right angles to the direction of movement. FIG. 15 shows a perspective view of another possible configuration of the conveyor in a helical form, making lifting possible from a lower level to a higher level and vice versa. FIG. 16 shows another possible configuration of the conveyor coupled to a battery of laying cages, the eggs (4) being loaded perpendicularly to the direction of movement, from the lowest portion to the highest portion. FIG. 18 shows another possible configuration of the conveyor, the movement track being formed by the mounting of the side support (6) and lower support (1) on a welded-link chain. FIG. 20 shows a front view of an extreme configuration of the side support 6 and lower support 1 but which still allows the formation of ascending or descending bends to the right and to the left, where the last possible support point tends to equate to the radius of the largest possible product to be moved.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

1. A variable conveyor for raising ovate objects having a radius from a lower level to a higher level and unloading the ovate objects, the variable conveyor comprising:
a lower support configured to form a contact surface in which the contact surface of the lower support has a minimum radius equal to or greater than the radius of the ovate object to be moved, wherein the lower support provides at least one support point for the ovate object, said support point forming an area of contact with the ovate object; and
a side support with opposed concave surfaces which have a minimum radius equal to or greater than the radius of the ovate object to be moved, wherein each concave surface has at least one support point for the ovate object, forming an area of contact with the ovate object, wherein the opposed concave surfaces have a last possible support point in a direction towards the outside of the conveyor, situated at an intersection of two lines, the first of said two intersecting lines running parallel with the centre of gravity of the ovate object, at a distance from said centre of gravity between a minimum of 2 mm and a maximum equal to the radius of the ovate object, and the second of said two intersecting lines running perpendicular to said centre of gravity in the direction of the opposed concave surfaces, at a distance from said centre of gravity between a minimum value equal to the radius of the largest ovate object minus one mm and a maximum value equal to 1 mm.

2. The variable conveyor according to claim 1, further comprising a movement track formed by mounting on a roller chain, wherein at least one lower support and one side support is mounted on the movement track.

3. The variable conveyor according to claim 1, comprising a movement track formed by mounting on a plurality of “side bow” type roller chains, at least one lower support and one side support to the right of the at least one lower support and one side support to the left of the at least one lower support.

4. The variable conveyor according to claim 1, wherein the side support has empty space between an adjacent sequence of side support, lower support and side support.

5. The variable conveyor according to claim 1, comprising a movement track formed by the consecutive and intercalated mounting on a “side bow” type roller chain of a lower support and a side support so as to form an uninterrupted movement track.

6. (canceled)

7. The variable conveyor according to claim 1, wherein both a first and second side supports have some empty space between the next sequence of first side support, lower support and second side support.

8. The variable conveyor according to claim 1, comprising a movement track formed by mounting on at least one to a plurality of link-chains made of plastic, composites or steel, at least one lower support and one side support to the right of the lower support and one side support to the left of the lower support.

9. The variable conveyor according to claim 1, comprising a movement track formed by mounting on at least one to a plurality of link-chains made of plastic, composites or steel, at least one lower support and one side support to the right of the lower support and one side support to the left of the lower support, both supports having some empty space between the next sequence of side support, lower support and side support.

10. The variable conveyor according to claim 1, comprising a movement track formed by the consecutive and intercalated mounting on at least one to a plurality of link-chains made of plastic, composites or steel of lower supports and side supports so as to form an uninterrupted movement track of a specified length.

11. The variable conveyor according to claim 1, comprising a movement track formed by anchoring in at least one to a plurality of cables or malleable strips of steel, composites or plastic, at least one lower support and one side support to the right of the lower support and one side support to the left of the lower support.

12. The variable conveyor according to claim 1, comprising a movement track formed by anchoring in at least one to a plurality of cables, malleable strips of steel, composites or plastic, at least one lower support and one side support to the right of the lower support and one side support to the left of the lower support, having some empty space between the next sequence of side support, lower support and side support.

13. The variable conveyor according to claim 1, comprising a movement track formed by the consecutive and intercalated anchoring in at least one to a plurality of cables, malleable strips of steel, composites or plastic, of one lower support and one side support so as to form an uninterrupted movement track of a specified length.

14. The variable conveyor according to claim 1, comprising a movement track formed by the consecutive and intercalated mounting of a lower support preceded and anteceded by a side support, the lower support and the side support having at least one to a plurality of connection elements integrated into the structure of said supports which cannot be dissociated from said supports, so as to be interconnected, forming the movement track without the use of other connection elements such as link-chains, roller chains, “side bow” type roller chains or cables, and malleable strips of steel, composites or plastic, so that the connection element or elements integrated into the structure of the lower support and side support can be used for driving forming the movement track.

15. The variable conveyor according to claim 1, comprising a movement track formed by the consecutive and intercalated mounting of a lower support preceded and anteceded by a side support, the lower support and the side support having at least one to a plurality of connection elements integrated into the structure of said supports which cannot be dissociated from said supports, so as to be interconnected with the use of a pin made of steel, plastic or composite, forming the movement track without the use of other connection elements such as link-chains, roller chains, “side bow” type roller chains or cables or malleable strips of steel, composites or plastic so that the connection element or elements integrated into the structure of the lower support and side support can be used for forming the movement track.
